(19) United States
(12) Patent Application Publication
(10) Pub. No.: US 2024/0310491 A1
(43) Pub. Date: Sep. 19, 2024

(54) PHOTOELECTRIC CONVERSION DEVICE

(71) Applicant: CANON KABUSHIKI KAISHA, Tokyo (JP)

(72) Inventor: SHOGO YAMASAKI, Kanagawa (JP)

(21) Appl. No.: 18/603,711

(22) Filed: Mar. 13, 2024

(30) Foreign Application Priority Data
Mar. 15, 2023 (JP) 2023-040928

(51) Int. Cl. G01S 7/481; G01S 7/4865; G01S 17/894

(52) U.S. Cl. CPC G01S 7/4816; G01S 7/4865; G01S 17/894

(57) ABSTRACT

A photoelectric conversion device includes a light receiving unit and a plurality of pixel control units. A first pixel control unit controls a first exposure period in a first pixel among a plurality of pixels based on a first exposure control signal, generates a second exposure control signal by delaying the first exposure control signal, and outputs the second exposure control signal to a second pixel control unit. When the first exposure control signal is enabled, the second pixel control unit controls a second exposure period such that a start time of the second exposure period coincides with a start time of the first exposure period. When the second exposure control signal is enabled, the second pixel control unit controls the second exposure period such that the start time of the second exposure period is later than the start time of the first exposure period.

### BACKGROUND

### Field

The present disclosure relates to a photoelectric conversion device.

### Description of the Related Art

U.S. Patent Application Publication No. 2017/0052065 discloses a ranging device that measures a distance to an object by emitting light from a light source and receiving light including reflected light from the object by a light receiving element. U.S. Patent Application Publication No. 2017/0052065 discloses a method of repeatedly performing measurement while changing a gating period during which photons are detected in a light receiving element.

In the ranging method disclosed in U.S. Patent Application Publication No. 2017/0052065, since it is necessary to repeatedly perform light emission and light reception while changing the gating period, the time required for one ranging may be long. Therefore, in the ranging method, it may be difficult to improve the frame rate.

### SUMMARY

According to a disclosure of the present specification, a photoelectric conversion device includes a light receiving unit and a plurality of pixel control units. The light receiving unit includes a plurality of pixels each configured to detect incident light and generate a signal based on the incident light. The plurality of pixel control units each is configured to control an exposure period during which a signal based on the incident light is generated in a corresponding pixel among the plurality of pixels. The plurality of pixel control units includes a first pixel control unit and a second pixel control unit. The first pixel control unit controls a first exposure period in a first pixel among the plurality of pixels based on a first exposure control signal, generates a second exposure control signal by delaying the first exposure control signal, and outputs the second exposure control signal to the second pixel control unit. The second pixel control unit controls a second exposure period in a second pixel among the plurality of pixels based on the second exposure control signal. The second pixel control unit includes a selection circuit configured to enable either the first exposure control signal or the second exposure control signal based on a selection signal. In a case where the first exposure control signal is enabled, the second pixel control unit controls the second exposure period based on the first exposure control signal such that a start time of the second exposure period coincides with a start time of the first exposure period. In a case where the second exposure control signal is enabled, the second pixel control unit controls the second exposure period based on the second exposure control signal such that the start time of the second exposure period is later than the start time of the first exposure period.

Further features of the disclosure will become apparent from the following description of exemplary embodiments with reference to the attached drawings.

### BRIEF DESCRIPTION OF THE DRAWINGS

FIG. 1 is a hardware block diagram illustrating a schematic configuration example of a ranging device according to a first embodiment.

FIG. 2 is a functional block diagram illustrating a schematic configuration example of the ranging device according to the first embodiment.

FIG. 3 is a diagram illustrating an outline of ranging frame acquisition according to the first embodiment.

FIG. 4 is a flowchart illustrating the operation of the ranging device according to the first embodiment.

FIG. 5 is a diagram illustrating a more specific configuration of a pixel control unit and a pixel according to the first embodiment.

FIG. 6 is a timing chart illustrating an example of the operation of the ranging device according to the first embodiment.

FIG. 7 is a diagram illustrating a configuration of a pixel control unit and a pixel according to a second embodiment.

FIG. 8 is a diagram illustrating a configuration of a pixel control unit and a pixel according to a third embodiment.

FIG. 9 is a timing chart illustrating an example of the operation of the ranging device according to the third embodiment.

FIG. 10 is a schematic diagram illustrating the overall configuration of a photoelectric conversion device according to a fourth embodiment.

FIG. 11 is a schematic block diagram illustrating a configuration example of a sensor substrate according to the fourth embodiment.

FIG. 12 is a schematic block diagram illustrating a configuration example of a circuit substrate according to the fourth embodiment.

FIG. 13 is a schematic block diagram illustrating a configuration example of one pixel of the photoelectric conversion unit and the pixel signal processing unit according to the fourth embodiment.

FIGS. 14A, 14B, and 14C are diagrams illustrating the operation of the avalanche photodiode according to the fourth embodiment.

FIG. 15A is a schematic diagram of the pixel array according to a fifth embodiment, and FIG. 15B is a driving timing diagram according to the fifth embodiment.

FIG. 16A is a schematic diagram of the pixel array according to a sixth embodiment, and FIG. 16B is a driving timing diagram according to the sixth embodiment.

FIGS. 17A and 17B are schematic diagrams of equipment according to a seventh embodiment.

### DESCRIPTION OF THE EMBODIMENTS

Hereinafter, embodiments of the present disclosure will be described with reference to the drawings. In the drawings, the same or corresponding elements are denoted by the same reference numerals, and the description thereof may be omitted or simplified.

### First Embodiment

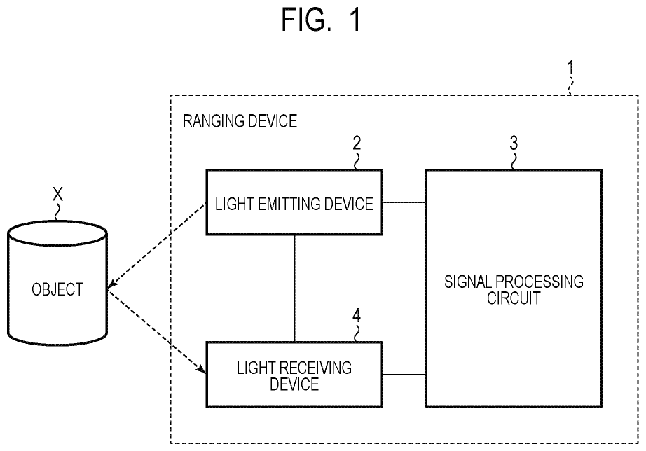

FIG. 1 is a hardware block diagram illustrating a schematic configuration example of a ranging device 1 according to the present embodiment. The ranging device 1 includes a light emitting device 2, a signal processing circuit 3, and a light receiving device 4. Note that the configuration of the ranging device 1 illustrated in the present embodiment is an example, and is not limited to the illustrated configuration.

The ranging device 1 measures a distance to an object X by using a technology such as LiDAR (Light Detection And Ranging). The ranging device 1 measures the distance from the ranging device 1 to the object X based on the time difference until the light emitted from the light emitting device 2 is reflected by the object X and received by the light receiving device 4. Further, the ranging device 1 can measure the distances at a plurality of points in a two-dimensional manner by emitting laser light to a predetermined ranging area including the object X and receiving reflected light by a pixel array. Thus, the ranging device 1 can generate and output a distance image. Such a scheme is sometimes referred to as a flash LiDAR.

The light received by the light receiving device 4 includes ambient light such as sunlight in addition to the reflected light from the object X. Therefore, the ranging device 1 performs ranging in which the influence of ambient light is reduced by using a method of generating a frequency distribution in which incident light is counted in each of a plurality of periods (bin periods) and determining that reflected light is incident in a period in which the light amount peaks.

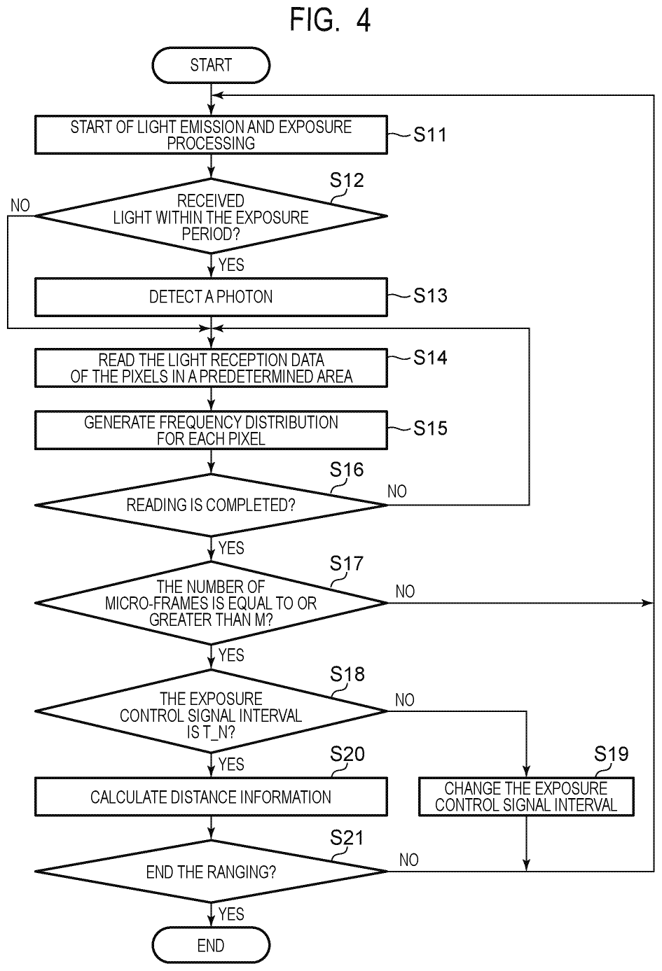

The light emitting device 2 emits light such as laser light to the outside of the ranging device 1. The signal processing circuit 3 may include a processor that performs arithmetic processing of digital signals, a memory that stores digital signals, and the like. The memory may be, for example, a semiconductor memory. The memory may contain instructions or programs that, when executed by the processor, cause the processor to perform operations described in the following, such as the flowchart in FIG. 4. Alternatively, these operations may be implemented by circuit elements such as logic circuits, gates, latches, or any specialized circuits.

The light receiving device 4 generates a pulse signal including a pulse based on the incident light. The light receiving device 4 is, for example, a photoelectric conversion device including an avalanche photodiode as a photoelectric conversion element. In this case, when one photon is incident on the avalanche photodiode and a charge is generated, one pulse is generated by avalanche multiplication. However, the light receiving device 4 may use, for example, a photoelectric conversion element using another photodiode.

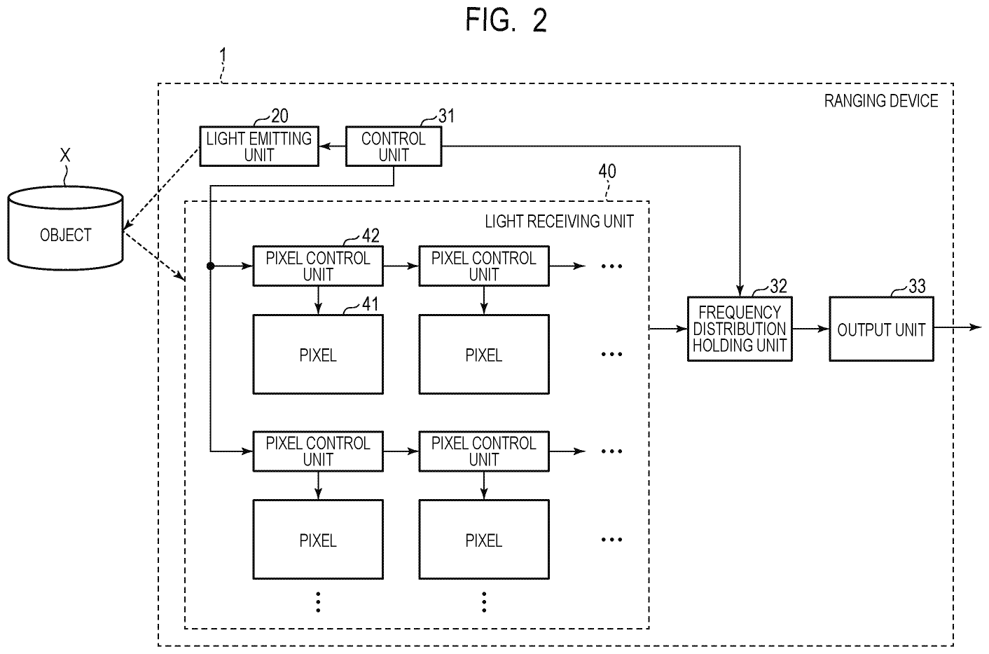

FIG. 2 is a functional block diagram illustrating a schematic configuration example of the ranging device 1 according to the present embodiment. The ranging device 1 includes a light emitting unit 20, a light receiving unit 40, a control unit 31, a frequency distribution holding unit 32, and an output unit 33. The term “unit” may refer to a circuit, a hardware element, or a device.

The light receiving unit 40 includes a plurality of pixels 41 arranged to form a plurality of rows and a plurality of columns. Each of the plurality of pixels 41 includes a photoelectric conversion element and a pixel circuit for reading out a signal from the photoelectric conversion element. In the following description, the photoelectric conversion element is assumed to be an avalanche photodiode.

The light receiving unit 40 includes a plurality of pixel control units 42 disposed so as to correspond to the plurality of pixels 41, respectively. That is, similarly to the plurality of pixels 41, the plurality of pixel control units 42 are arranged to form a plurality of rows and a plurality of columns. The pixel control unit 42 controls an exposure period during which a signal based on incident light is generated in the corresponding pixel 41. The corresponding pixel 41 is a pixel that is associated with, or connected to, a particular circuit or subcircuit within the pixel control unit 42.

The light receiving unit 40 and the light emitting unit 20 correspond to the light receiving device 4 and the light emitting device 2 in FIG. 1, respectively. The control unit 31, the frequency distribution holding unit 32, and the output unit 33 correspond to the signal processing circuit 3 in FIG. 1.

The control unit 31 outputs a light emission control signal for controlling the timing of light emission to the light emitting unit 20. The control unit 31 outputs an exposure control signal corresponding to the ranging distance and a scanning signal of the pixel 41 to the light receiving unit 40. The control unit 31 outputs a control signal for controlling the operation of the frequency distribution holding unit 32. This control signal has a function of controlling, for example, the timing of starting and ending a frame.

The exposure control signal output from the control unit 31 is input to the pixel control unit 42 in the leftmost column (first column) of the light receiving unit 40. The pixel control unit 42 outputs an exposure control signal to the corresponding pixel 41, and outputs the exposure control signal to the pixel control unit 42 of the adjacent column (second column). The pixel control unit 42 in the first column has a function of delaying the exposure control signal by a predetermined time and outputting the delayed signal to the pixel control unit 42 in the second column.

The photoelectric conversion element of the pixel 41 converts light into an electric signal when a photon is detected within an exposure period in which an exposure control signal output from the pixel control unit 42 is enabled. The pixel circuit of the pixel 41 outputs the electric signal converted by the photoelectric conversion unit to the pixel output signal line. The light receiving unit 40 includes a vertical scanning circuit (not illustrated) which receives a control pulse supplied from the control unit 31 and supplies the control pulse to each pixel 41. A logic circuit such as a shift register or an address decoder can be used for the vertical scanning circuit. A signal output from the photoelectric conversion unit of each pixel 41 is processed in a pixel circuit of each pixel 41. A memory is provided in the pixel circuit, and the memory holds a digital signal indicating whether or not light is received by the pixel 41. This digital signal is a 1-bit signal constituting a micro-frame.

The digital signals output from the plurality of pixels 41 are held in the frequency distribution holding unit 32. Since the measurement distance is proportional to the flight time of the light, the time from the light emission defined by the exposure control signal to the light reception by the light receiving unit 40 corresponds to the measurement distance. In the present embodiment, measurement of a plurality of micro-frames is performed for each distance. Then, a plurality of distances are measured while changing the time from the light emission to the enabling of the exposure control signal. The frequency distribution holding unit 32 accumulates the micro-frames for each class corresponding to the distance, thereby generating a frequency distribution in which the class and the frequency are associated with each other with the distance as a class and the number of times of light reception as a frequency. The frequency distribution holding unit 32 has a memory for holding the frequency distribution.

The output unit 33 is an interface that outputs information to the outside of the ranging device 1 in a predetermined format. The information held in the frequency distribution holding unit 32 may be directly output to an external signal processing device via the output unit 33. Alternatively, the frequency distribution holding unit 32 may perform peak detection processing for detecting a peak from the frequency distribution to generate distance information, and the output unit 33 may output the distance information to an external signal processing device.

The light receiving unit 40 of the present embodiment can perform an operation of delaying the exposure control signal input to the pixels 41 in the first row and the second column by a predetermined time than the exposure control signal input to the pixels 41 in the first row and the first column as described above. In this case, since the plurality of pixels 41 can perform the exposure operation in different periods, light can be received in a plurality of exposure periods by one light emission. That is, ranging is performed at a plurality of distances by one light emission. Thereby, although the resolution in the light receiving surface of the light receiving unit 40 decreases, the frame rate can be improved.

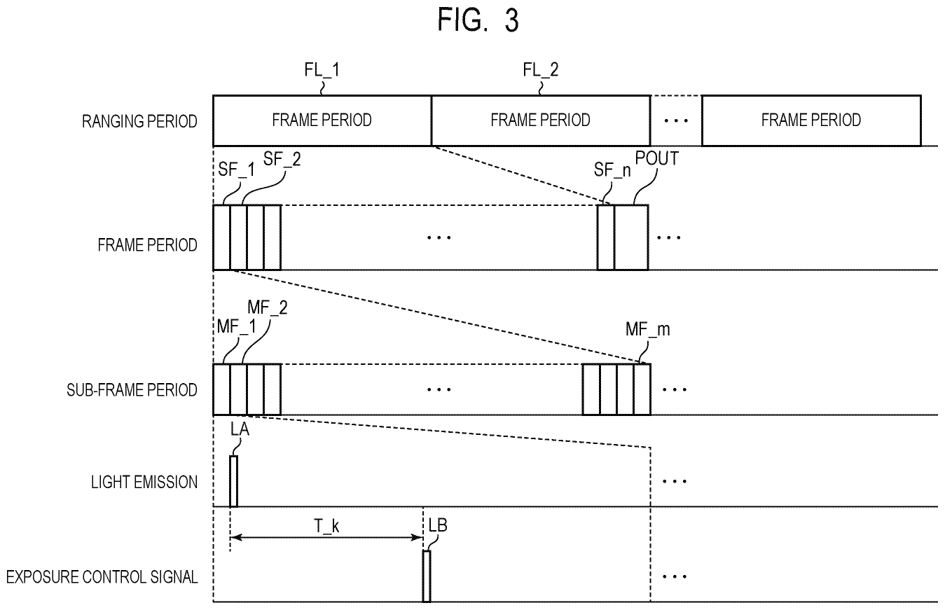

FIG. 3 is a diagram illustrating an outline of ranging frame acquisition according to the present embodiment. FIG. 3 schematically illustrates acquisition periods of a ranging frame corresponding to one ranging result, a sub-frame used for generation of the ranging frame, and a micro-frame used for generation of the sub-frame by arranging blocks in the horizontal direction. The horizontal direction in FIG. 3 indicates the elapse of time, and one block indicates the acquisition period of one ranging frame, sub-frame, or micro-frame. FIG. 3 illustrates a control signal for controlling the light emission period of the light emitting unit 20 and an exposure control signal for controlling the exposure period of the light receiving unit 40. In the following description of FIGS. 3 and 4, a driving method in which a plurality of pixels 41 perform exposure operation in different periods to perform ranging at a plurality of distances by one light emission is not considered.

In the “ranging period” of FIG. 3, a plurality of frame periods FL_1, FL_2, . . . included in one ranging period are illustrated. The frame period FL_1 indicates a first frame period in one ranging period, and the frame period FL_2 indicates a second frame period in one ranging period. The frame period is a period in which the ranging device 1 performs one ranging and outputs a signal indicating a distance (ranging result) from the ranging device 1 to the object X to the outside.

One ranging frame is generated from a plurality of sub-frames. In the “frame period” of FIG. 3, a plurality of sub-frame periods SF_1, SF_2, . . . , SF_n included in one frame period and a peak output period POUT for determining a peak from a frequency distribution and outputting the peak are illustrated. The sub-frame period SF_1 indicates a first sub-frame period in one frame period, and the sub-frame period SF_2 indicates a second sub-frame period in one frame period. In the present embodiment, the number of sub-frames is n per frame (n is an integer equal to or greater than 2). The sub-frame period SF_n indicates an n-th sub-frame period in one frame period.

One sub-frame is generated from a plurality of micro-frames. In the “sub-frame period” of FIG. 3, a plurality of micro-frame periods MF_1, MF_2, . . . , MF_m included in one sub-frame period are illustrated. The micro-frame period MF_1 indicates a first micro-frame period in one sub-frame period, and the micro-frame period MF_2 indicates a second micro-frame period in one sub-frame period. In the present embodiment, the number of micro-frames is m per sub-frame (m is an integer equal to or greater than 2). The micro-frame period MF_m indicates the m-th micro-frame period in one sub-frame period. The number m of the micro-frames corresponds to the number of accumulations of the light reception results.

In FIG. 3, “light emission” and “exposure control signal” indicate the light emission period of the light emitting unit 20 and the exposure control signal input to the light receiving unit 40 in one micro-frame period. The light emitting unit 20 emits light during the light emission period LA in which the “light emitting” is at the high level. When light is incident on the pixel 41 of the light receiving unit 40 during the exposure period LB in which the “exposure control signal” is at the high level, the pixel 41 detects the incident light. A period T_k from the start of the light emission period LA to the start of the exposure period LB corresponds to a flight time of light from light emission to light reception. That is, the length of the period T_k corresponds to the ranging distance in the corresponding micro-frame. Note that k is a number of a corresponding sub-frame period and is an integer from 1 to n.

In each of the plurality of micro-frame periods MF_1, MF_2, . . . , MF_m, the lengths of the periods T_k from the start of the light emission period LA to the start of the exposure period LB are the same. That is, in one sub-frame period, the light reception data is read (micro-frame acquisition) m times. When one or more photons are detected within one micro-frame period in each pixel 41, the pixel outputs “1” as light reception data. By accumulating m micro-frames acquired in one sub-frame period, data indicating the number of micro-frames in which a photon has been detected is generated.

In each of the plurality of sub-frame periods SF_1, SF_2, . . . , SF_n, the lengths of the periods T_1, T_2, . . . , T_n are different from each other. Thereby, in the plurality of sub-frame periods SF_1, SF_2, . . . , SF_n, a frequency distribution of light reception at different distances is acquired. In the peak output period POUT, a peak (maximum value) is detected from the frequency of each of the sub-frame periods SF_1, SF_2, . . . , SF_n. The length of the period T_k corresponding to this peak is proportional to the distance from the ranging device 1 to the object X.

FIG. 4 is a flowchart illustrating the operation of the ranging device 1 according to the present embodiment. FIG. 4 illustrates the operation from the start to the end of the ranging period. One round of processing in the loop from step S11 to step S19 represents processing for acquiring one sub-frame in FIG. 3. The processing of one cycle in the loop from step S11 to step S17 represents the processing of acquiring one micro-frame in FIG. 3.

In step S11, the control unit 31 controls the light emitting unit 20 to emit pulsed light within a predetermined area of ranging. The control unit 31 controls the light receiving unit 40 to start exposure processing for detecting incident light. When the processing in step S11 is the first time, the period (exposure control signal interval) corresponding to the interval between light emission and light reception is set to T_1.

In step S12, when a photon is incident on a certain pixel 41 within the exposure period (YES in step S12), the processing proceeds to step S13, and the pixel 41 generates a photon detection signal (light receiving pulse) indicating detection of the photon. The photon detection signal is held as light reception data in a memory in the pixel 41. With respect to the pixel 41 in which no photon is incident within the exposure period (NO in step S12), the processing proceeds to step S14. The processes of steps S12 and S13 are performed in parallel in each pixel 41.

In step S14, under the control of the read scan of the control unit 31, the light reception data is read out to the frequency distribution holding unit 32 for each predetermined unit area of the pixels 41.

In step S15, the light reception data is added in the frequency distribution holding unit 32 for each pixel 41. Thereby, a frequency distribution for each pixel 41 is generated.

In step S16, the control unit 31 determines whether or not the reading of all the pixel data of the reading target area is completed. When the reading is not completed (NO in step S16), the processing proceeds to step S14, and the reading is continued by changing the reading area. When the reading is completed (YES in step S16), the processing proceeds to step S17.

In step S17, the control unit 31 determines whether or not the number of micro-frames acquired in the sub-frame is equal to or greater than m. When the number of acquired micro-frames is less than m (NO in step S17), the processing proceeds to step S11, and the next micro-frame is acquired. When the number of acquired micro-frames is equal to or greater than m (YES in step S17), the processing proceeds to step S18. By this processing, m micro-frames are acquired and accumulated.

In step S18, the control unit 31 determines whether or not the exposure control signal interval is T_n (exposure control signal interval in the last sub-frame). When the exposure control signal interval is not T_n (NO in step S18), the processing proceeds to step S19. When the exposure control signal interval is T_n (YES in step S18), the processing proceeds to step S20.

In step S19, the control unit 31 changes the setting value of the exposure control signal interval to a value for the next sub-frame. For example, when the exposure control signal interval is T_1, the control unit 31 changes the exposure control signal interval to T_2. Then, the processing proceeds to step S11, where the next sub-frame is acquired.

In step S20, the frequency distribution holding unit 32 has already acquired the frequency distribution of n kinds of exposure control signal intervals from T_1 to T_n. The frequency distribution holding unit 32 or an external signal processing device performs a peak detection processing for detecting a peak of the frequency distribution to generate distance information. The peak detection processing may be processing of obtaining the maximum value of the frequency over a plurality of acquired classes and calculating the distance from the ranging device 1 to the object X based on the exposure control signal interval corresponding to the maximum value. More specifically, when the exposure control signal interval corresponding to the peak is T_p and the light speed is c (about 300,000 km/s), the distance Y can be calculated by Y=c×T_p/2.

In step S21, the control unit 31 determines whether or not to end the ranging. When it is determined that the ranging is to be ended (YES in step S21), the processing ends. When it is determined that the ranging is not to be ended (NO in step S21), the processing proceeds to step S11, and the next ranging frame is acquired.

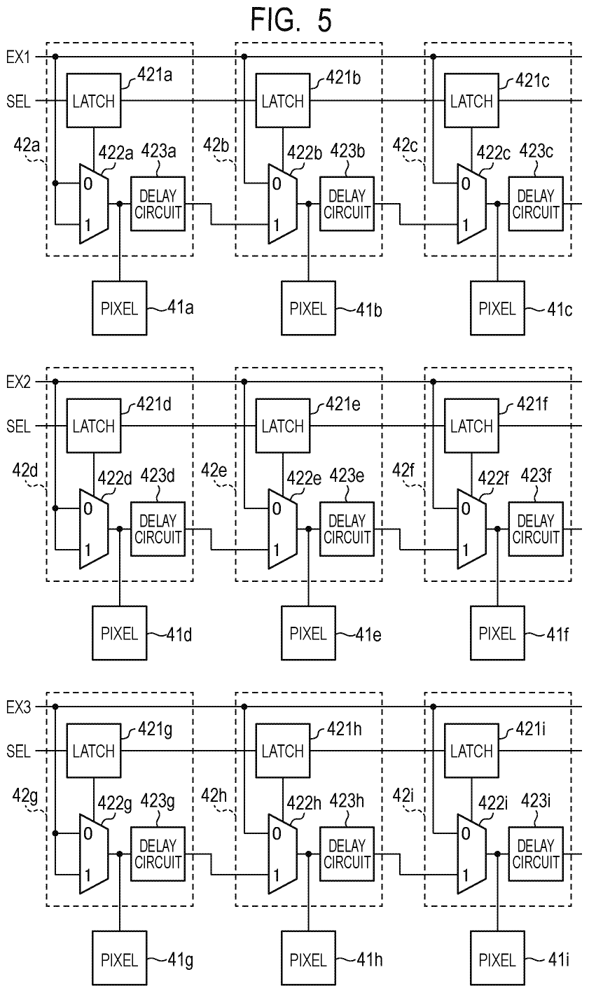

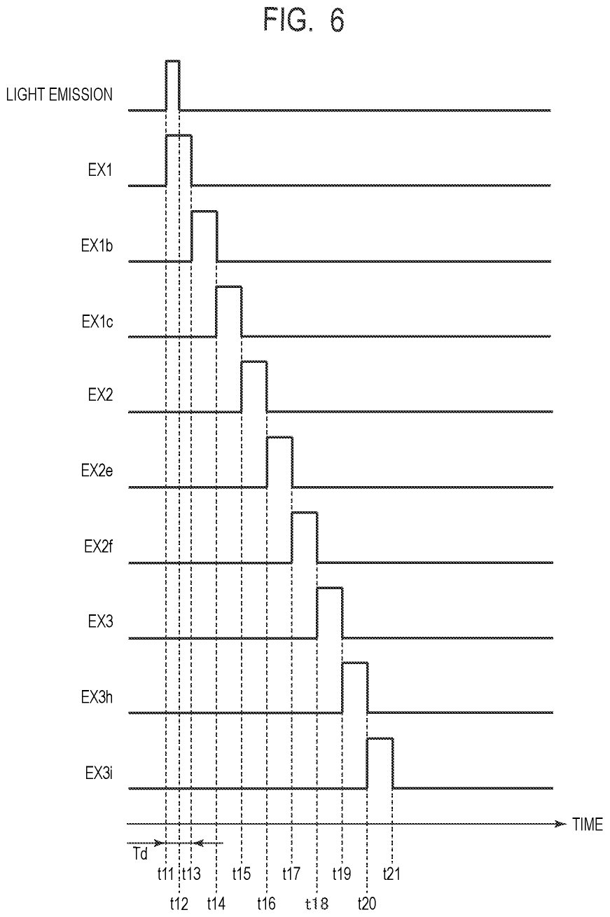

Next, the control of the exposure period in the pixel control unit 42 and the pixel 41 will be described in detail with reference to FIGS. 5 and 6. FIG. 5 is a diagram illustrating a more specific configuration of the pixel control unit 42 and the pixel 41 according to the present embodiment.

FIG. 5 illustrates nine pixels 41 arranged in three rows and three columns and nine pixel control units 42 corresponding thereto. In FIG. 5, pixel control units 42a, 42b, and 42c and pixels 41a, 41b, and 41c are arranged in a first row. The pixels 41a, 41b, and 41c may be the pixels corresponding to, or associated with, the pixel control units 42a, 42b, and 42c, respectively. In the second row, pixel control units 42d, 42e, and 42f and pixels 41d, 41e, and 41f are arranged. In the third row, pixel control units 42g, 42h, and 42i and pixels 41g, 41h, and 41i are arranged. That is, in FIG. 5, in order to distinguish between the nine elements, “a” to “i” are added to the end of the reference numerals of the elements. The pixel control unit 42a includes a latch 421a, a selection circuit 422a, and a delay circuit 423a. The other pixel control units 42b to 42i have similar circuit elements.

FIG. 5 illustrates signal lines of the exposure control signals EX1, EX2, EX3 and the selection signal SEL output from the control unit 31. The exposure control signal EX1 is input to the pixel control units 42a, 42b, and 42c of the first row in common. The exposure control signal EX2 is input to the pixel control units 42d, 42e, and 42f of the second row in common. The exposure control signal EX3 is input to the pixel control units 42g, 42h, and 42i of the third row in common. The selection signal SEL is input to the nine pixel control units 42a to 42i in common. That is, the selection signal SEL of a common level is input to the selection circuits 422a to 422i of the pixel control units 42a to 42i.

Since the configurations of the first row to the third row are the same except for the input exposure control signal, the configuration of the first row will be mainly described below. The exposure control signal EX1 is input to a first input terminal of the selection circuit 422a, a second input terminal of the selection circuit 422a, a first input terminal of the selection circuit 422b, and a first input terminal of the selection circuit 422c. In FIG. 5, in the circuit symbol of each selection circuit, a terminal indicated by “0” is referred to as a first input terminal, and a terminal indicated by “1” is referred to as a second input terminal. Each selection circuit enables either an input signal to the first input terminal or an input signal to the second input terminal according to the level of the signal input to the control terminal and outputs the enabled input signal from the output terminal.

The selection signal SEL is input to the latches 421a, 421b, and 421c in common. The latches 421a, 421b, and 421c have a function of holding a 1-bit signal. That is, the latches 421a, 421b, and 421c hold a value of “0” or “1” according to the level of the selection signal SEL. The values held in the latches 421a, 421b, and 421c are input to the control terminals of the selection circuits 422a, 422b, and 422c, respectively. Each of the selection circuits 422a, 422b, and 422c outputs a signal inputted to the first input terminal when the value inputted to the control terminal is “0”, and outputs a signal inputted to the second input terminal when the value inputted to the control terminal is “1”. The holding of the value to the latches 421a, 421b, and 421c by the selection signal SEL may be performed when the ranging device 1 is started.

The output terminal of the selection circuit 422a is connected to the control terminal of the pixel 41a and the input terminal of the delay circuit 423a. An output terminal of the delay circuit 423a is connected to a second input terminal of the selection circuit 422b. The exposure control signal output from the selection circuit 422a is input to the pixel 41a to control the exposure period of the pixel 41a, and is input to the pixel control unit 42b via the delay circuit 423a.

The output terminal of the selection circuit 422b is connected to the control terminal of the pixel 41b and the input terminal of the delay circuit 423b. An output terminal of the delay circuit 423b is connected to a second input terminal of the selection circuit 422c. The exposure control signal output from the selection circuit 422b is input to the pixel 41b to control the exposure period of the pixel 41b, and is input to the pixel control unit 42c via the delay circuit 423b. Since the connection relationship between the pixel control unit 42c and the pixel 41c is substantially the same, description thereof will be omitted.

FIG. 6 is a timing chart illustrating an example of the operation of the ranging device 1 according to the present embodiment. FIG. 6 illustrates the operation when the values of “1” are held in the latches 421a to 421i by the selection signal SEL. The high level period of “light emission” in FIG. 6 indicates the light emission period of the light emitting unit 20. In FIG. 6, “EX1”, “EX2”, and “EX3” indicate the levels of the exposure control signals EX1, EX2, and EX3, respectively. In FIG. 6, “EX1b”, “EX1c”, “EX2e”, “EX2f”, “EX3h”, and “EX3i” represent levels of exposure control signals input to the pixels 41b, 41c, 41e, 41f, 41h, and 41i, respectively. With reference to FIG. 6, an operation when the values of “1” are held in latches 421a to 421i by selection signal SEL and the second input terminal and the output terminal are conductive in selection circuits 422a to 422i will be described.

In the example of FIG. 6, it is assumed that the delay times Td of the delay circuits 423a to 423i are equal to each other and correspond to the time between the time t11 and the time t13. The pulse widths of the exposure control signals EX1, EX2, and EX3 are set equal to the delay time Td. It is assumed that the interval of each time from the time t13 to the time t21 is equal to the delay time Td. The delay times of the selection circuits 422a to 422i and the wirings are ignored.

During a period from the time t11 to the time t12, the light emitting unit 20 emits light. In addition, during a period from time t11 to time t13, the exposure control signal EX1 becomes the high level. An exposure control signal EX1 (first exposure control signal) is input to the pixel 41a via the selection circuit 422a without delay. In this manner, in the pixel 41a (first pixel) corresponding to the pixel control unit 42a (first pixel control unit) of the first column, exposure (counting of light receiving pulses based on incident light) is performed in the period (first exposure period) from the time t11 to the time t13. In the example of FIG. 6, the light emission timing of the light emitting unit 20 and the exposure start time based on the exposure control signal EX1 are the same, but the timings of those are not limited thereto. Due to the gate shift, exposure based on the exposure control signal EX1 may be started after a predetermined time has elapsed from the timing of light emission of the light emitting unit 20.

An exposure control signal EX1 is input to the pixel 41b via the selection circuit 422a, the delay circuit 423a, and the selection circuit 422b. The delay time of this path is Td. An exposure control signal (second exposure control signal) obtained by delaying the rising and falling of the exposure control signal EX1 by Td is input to the pixel 41b. In this manner, in the pixel 41b (second pixel) corresponding to the pixel control unit 42b (second pixel control unit) of the second column, exposure is performed in the period (second exposure period) from the time t13 to the time t14. The time t13 which is the start time of the second exposure period is later than the time t11 which is the start time of the first exposure period.

An exposure control signal EX1 is input to the pixel 41c via the selection circuit 422a, the delay circuit 423a, the selection circuit 422b, the delay circuit 423b, and the selection circuit 422c. The delay time of this path is 2 Td. An exposure control signal obtained by delaying the rising and falling of the exposure control signal EX1 by 2 Td is input to the pixel 41c. In this manner, in the pixel 41c corresponding to the pixel control unit 42c in the third column, exposure is performed in the period from the time t14 to the time t15.

During the period from the time t15 to the time t16, the exposure control signal EX2 becomes the high level. The exposure control signal EX2 is set to the high level at a time later than the exposure control signal EX1 by 3 Td. The pixel 41d receives the exposure control signal EX2 without delay through the selection circuit 422d. In this manner, in the pixel 41d corresponding to the pixel control unit 42d in the first column, exposure is performed in the period from the time t15 to the time t16.

Similarly to the pixels 41b and 41c described above, the delay circuits 423d and 423e delay the rising and falling of the exposure control signal EX2 by Td and 2 Td, respectively, and input to the pixels 41e and 41f. Thus, exposure is performed in the period from time t16 to time t17 in the pixel 41e of the second column, and exposure is performed in the period from time t17 to time t18 in the pixel 41f of the third column.

During the period from the time t18 to the time t19, the exposure control signal EX3 becomes the high level. The exposure control signal EX3 is set to the high level at a time later than the exposure control signal EX1 by 6 Td. An exposure control signal EX3 is input to the pixel 41g via the selection circuit 422g without delay. In this manner, in the pixel 41g corresponding to the pixel control unit 42g in the first column, exposure is performed in the period from the time t18 to the time t19.

Similarly to the pixels 41b and 41c described above, the delay circuits 423g and 423h delay the rising and falling of the exposure control signal EX3 by Td and 2 Td, respectively, and input to the pixels 41h and 41i. Thus, exposure is performed in the period from time t19 to time t20 in the pixel 41h of the second column, and exposure is performed in the period from time t20 to time t21 in the pixel 41i of the third column.

Nine pixels of three rows and three columns illustrated in FIG. 5 are treated as one macro pixel. The nine pixels sequentially perform exposure in nine different periods. Thus, the macro pixel can perform ranging in nine kinds of distance ranges by one light emission. That is, the time required for one ranging may be shortened. Therefore, according to the present embodiment, a photoelectric conversion device capable of improving a frame rate is provided.

Further, in the ranging device 1 of the present embodiment, instead of the first driving method that focuses on the frame rate as illustrated in FIG. 6, the second driving method that focuses on the resolution in the light receiving surface can be performed. In the second driving method, the values of “0” are held in the latches 421a to 421i by the selection signal SEL, and the first input terminal and the output terminal are conductive in the selection circuits 422a to 422i. Further, in the second driving method, the exposure control signals EX1, EX2, and EX3 become the high level at the timing when the exposure control signals EX1, EX2, and EX3 coincide with each other. In this case, the exposure control signals EX1, EX2, and EX3 are input to the corresponding pixels without delay without passing through the delay circuits 423a to 423i. Accordingly, in the second driving method, exposure is performed simultaneously in the nine pixels 41a to 41i. Since the nine pixels 41a to 41i can receive light individually in the same period, by applying the second driving method, the resolution in the light receiving surface is improved as compared with the case of the first driving method.

In the first exposure method illustrated in FIG. 6, although the frame rate is improved, the resolution in the light receiving surface of the light receiving unit 40 is reduced. On the other hand, according to the second driving method, it is possible to perform ranging focusing on the resolution in the light receiving surface rather than the frame rate. Therefore, in the configuration of the present embodiment, appropriate ranging can be performed in consideration of the tradeoff between the frame rate and the resolution by changing the driving method. Further, since the latch and the selection circuit arranged for each pixel perform this switching, there is an advantage in that the degree of congestion of the wiring hardly increases even when the number of pixels is large. However, the second driving method may not be performed, and only the first driving method may be performed. That is, the latches 421a to 421i and the selection circuits 422a to 422i are not essential.

The frequency distribution holding unit 32 of the present embodiment is assumed to store all the micro-frames, but may be configured not to hold some data. For example, the storage capacity may be reduced by employing a method of holding only the maximum value of a plurality of sub-frames.

In the example illustrated in FIG. 6, the interval between the exposure periods of the pixels 41a to 41i is equal to the delay time of the delay circuits 423a to 423i. Although this is not essential, it is possible to reduce the overlap or gap in the exposure period of each of the pixels 41a to 41i and improve the accuracy of the ranging. In the example illustrated in FIG. 6, the lengths of the exposure periods of the pixels 41a to 41i are the same. Although this is not essential, ranging can be performed at a constant distance resolution by setting in this manner.

### Second Embodiment

In the present embodiment, a modified example in which one pixel control unit 42 is disposed so as to correspond to a pixel group including a plurality of pixels 41 will be described. In the present embodiment, the description of elements common to those of the first embodiment may be omitted or simplified.

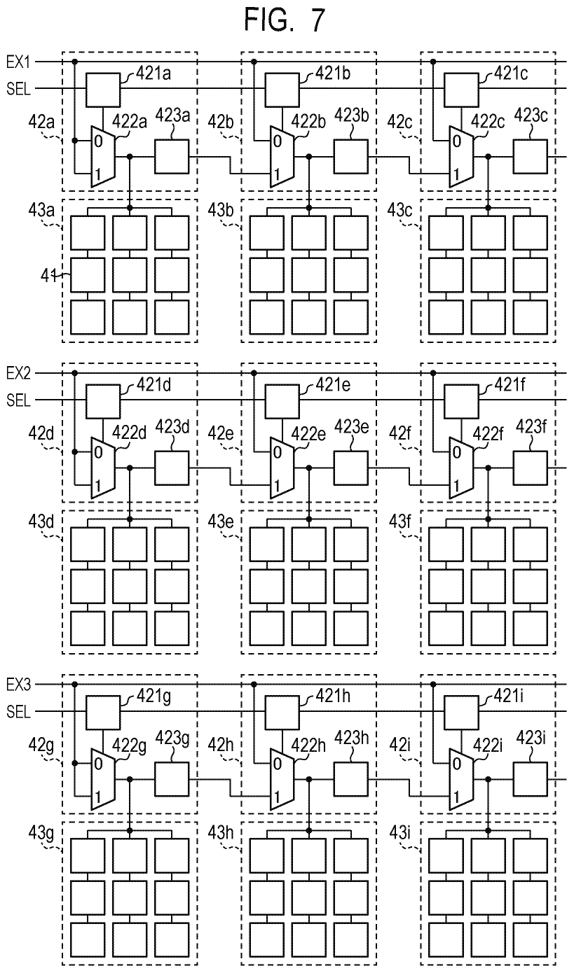

FIG. 7 is a diagram illustrating the configuration of the pixel control unit 42 and the pixel 41 according to the present embodiment. In the present embodiment, one pixel 41 in FIG. 5 of the first embodiment is replaced with a pixel group 43. One pixel group 43 includes nine pixels 41 arranged in three rows and three columns. The pixel control unit 42 performs control to operate nine pixels in one pixel group 43 in a common exposure period. FIG. 7 illustrates nine pixel control units 42a to 42i arranged in three rows and three columns and nine pixel groups 43a to 43i, and these may be driven in the same manner as in the first embodiment.

A plurality of pixels 41 belonging to the pixel group 43 of the present embodiment are treated as one pixel. This is referred to as binning processing. In the binning processing, the signals based on the photons incident on the plurality of pixels 41 are summed and counted, and the frequency distribution in which the plurality of pixels 41 belonging to the pixel group 43 are regarded as the same pixel is generated. That is, in this frequency distribution, the frequencies output from a plurality of pixels treated as the same pixel are processed as a common class indicating the same distance. By performing the binning processing, although the resolution in the light receiving surface is reduced, the substantial light receiving area is enlarged, so that the probability of receiving reflected light from the object X is improved. Thereby, the distance range in which the distance can be measured can be enlarged.

In the present embodiment, the number of pixel control units 42 is smaller than the number of pixels 41. As a result, compared to the configuration of the first embodiment, the total occupied area of the plurality of pixel control units 42 can be reduced, and the interval between the pixels 41 can be reduced. As a result, the sensitivity can be improved by enlarging the light receiving area, the number of pixels 41 can be increased, and the size of the ranging device 1 can be reduced. It is also possible to increase the area of the delay circuit 423 to improve the control accuracy of the exposure period.

According to the present embodiment, a photoelectric conversion device capable of improving a frame rate is provided as in the first embodiment. In addition, at least one of the above-described quality improvement effects can be obtained by reducing the occupied area of the pixel control unit 42.

### Third Embodiment

In the present embodiment, a modified example in which one pixel control unit 42 is disposed so as to correspond to a plurality of pixels 41 in one column will be described. In the present embodiment, the description of elements common to those of the first embodiment may be omitted or simplified.

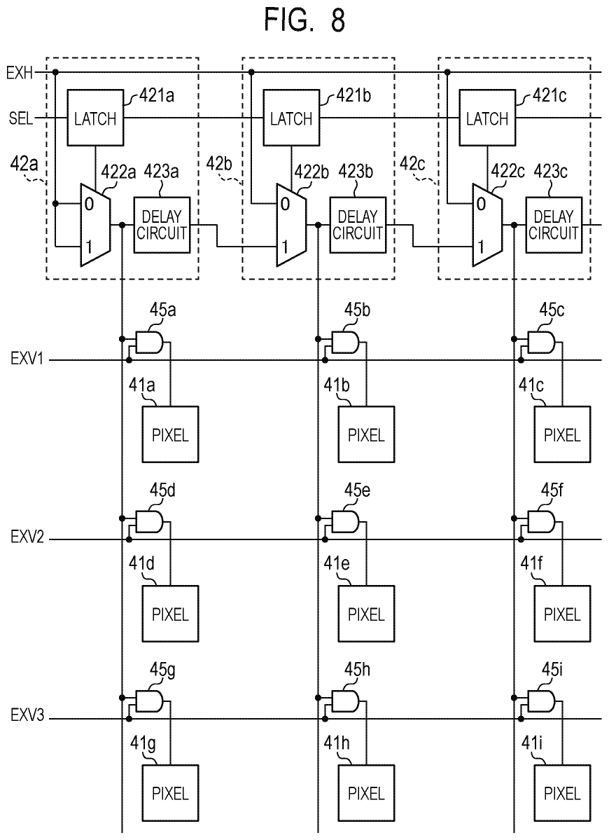

FIG. 8 is a diagram illustrating the configuration of the pixel control unit 42 and the pixel 41 according to the present embodiment. In the first embodiment, one pixel control unit 42 controls one pixel 41, but in the present embodiment, one pixel control unit 42 controls three pixels 41 in the same column. That is, the pixel control unit 42a controls the pixels 41a, 41d, and 41g, the pixel control unit 42b controls the pixels 41b, 41e, and 41h, and the pixel control unit 42c controls the pixels 41c, 41f, and 41i. A horizontal exposure control signal EXH is input to the pixel control units 42a, 42b, and 42c.

In the light receiving unit 40 of the present embodiment, the AND circuits 45a to 45i are disposed so as to correspond to the plurality of pixels 41a to 41i, respectively. Each of the AND circuits 45a to 45i is a logic circuit that outputs the logical product of the input signals of the first input terminal and the second input terminal from the output terminal.

An output terminal of the selection circuit 422a is connected to first input terminals of the AND circuits 45a, 45d, and 45g and an input terminal of the delay circuit 423a. An output terminal of the selection circuit 422b is connected to first input terminals of the AND circuits 45b, 45e, and 45h and an input terminal of the delay circuit 423b. An output terminal of the selection circuit 422c is connected to first input terminals of the AND circuits 45c, 45f, and 45i and an input terminal of the delay circuit 423c. A vertical exposure control signal EXV1 (third exposure control signal) is input from the control unit 31 to second input terminals of the AND circuits 45a, 45b, and 45c. A vertical exposure control signal EXV2 is input from the control unit 31 to second input terminals of the AND circuits 45d, 45e, and 45f. A vertical exposure control signal EXV3 is input from the control unit 31 to second input terminals of the AND circuits 45g, 45h, and 45i. As described above, in the present embodiment, the exposure periods of the plurality of pixels 41a to 41i are controlled based on the combination of the horizontal exposure control signal EXH and the vertical exposure control signals EXV1, EXV2, and EXV3.

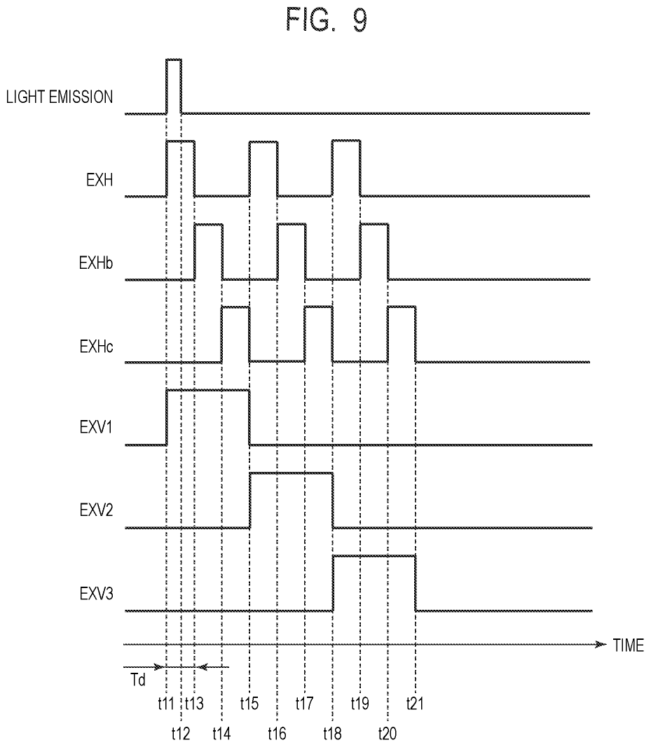

FIG. 9 is a timing chart illustrating an example of the operation of the ranging device 1 according to the present embodiment. FIG. 9 illustrates the operation when the values of “1” are held in the latches 421a to 421c by the selection signal SEL. The high level period of “light emission” in FIG. 9 indicates the light emission period of the light emitting unit 20. In FIG. 9, “EXH”, “EXV1”, “EXV2”, and “EXV3” indicate the levels of the horizontal exposure control signal EXH and the vertical exposure control signals EXV1, EXV2, and EXV3, respectively. In FIG. 9, “EXHb” and “EXHc” indicate levels of horizontal exposure control signals output from the selection circuits 422b and 422c, respectively.

In the example of FIG. 9, it is assumed that the delay times Td of the delay circuits 423a to 423c are equal to each other and correspond to the time between the time t11 and the time t13. The pulse width of the horizontal exposure control signal EXH is set equal to the delay time Td. The pulse widths of the vertical exposure control signals EXV1, EXV2, EXV3 are set to three times the delay time Td. It is assumed that the interval of each time from the time t13 to the time t21 is equal to the delay time Td. In addition, the delay times of the selection circuits 422a to 422c, the AND circuits 45a to 45i, and the wiring are ignored.

In the present embodiment, the horizontal exposure control signal EXH becomes the high level during the period from the time t11 to the time t13, during the period from the time t15 to the time t16, and during the period from the time t18 to the time t19. Similarly to the example of FIG. 6, the horizontal exposure control signal EXH is delayed by Td by delay circuits 423a and 423b. That is, the exposure control signal output from the pixel control unit 42a becomes high level during the period from the time t11 to the time t13, during the period from the time t15 to the time t16, and during the period from the time t18 to the time t19. The exposure control signal output from the pixel control unit 42b becomes high level during the period from the time t13 to the time t14, the period from the time t16 to the time t17, and the period from the time t19 to the time t20. The exposure control signal output from the pixel control unit 42c becomes high level during the period from the time t14 to the time t15, the period from the time t17 to the time t18, and the period from the time t20 to the time t21.

The vertical exposure control signal EXV1 becomes the high level during the period from the time t11 to the time t15, the vertical exposure control signal EXV2 becomes the high level during the period from the time t15 to the time t18, and the vertical exposure control signal EXV3 becomes the high level during the period from the time t18 to the time t21. That is, the vertical exposure control signal EXV2 is delayed by 3 Td from the vertical exposure control signal EXV1, and the vertical exposure control signal EXV3 is delayed by 3 Td from the vertical exposure control signal EXV2.

The exposure control signal output from the AND circuit 45a to the pixel 41a is a logical product of two signals (“EXH” and “EXV1” in FIG. 9) input to the AND circuit 45a. Therefore, an exposure control signal is input to the pixel 41a of the first row and the first column such that the exposure control signal becomes the high level during the period from the time t11 to the time t13.

The exposure control signal output from the AND circuit 45b to the pixel 41b is a logical product of two signals (“EXHb” and “EXV1” in FIG. 9) input to the AND circuit 45b. Accordingly, an exposure control signal is input to the pixel 41b of the first row and the second column so as to be at the high level during the period from the time t13 to the time t14.

Similarly, the exposure control signals generated by the AND circuits 45c to 45i are input to the other pixels 41c to 41i. That is, the high-level period of the exposure control signals input to the plurality of pixels 41a to 41i is the same as that of the first embodiment illustrated in FIG. 6, and exposures are performed in different periods in the plurality of pixels 41a to 41i. Accordingly, in the present embodiment, the same ranging as in the first embodiment can be performed.

In the present embodiment, since one pixel control unit 42 is shared by a plurality of pixels 41, the number of pixel control units 42 is smaller than the number of pixels 41. Thus, similarly to the second embodiment, the total occupied area of the plurality of pixel control units 42 is reduced, and the interval between the pixels 41 can be reduced.

According to the present embodiment, a photoelectric conversion device capable of improving a frame rate is provided as in the first embodiment. Further, in addition to this, a quality improvement effect can be obtained by reducing the occupied area of the pixel control unit 42.

The vertical exposure control signals EXV2 and EXV3 may be generated by the control unit 31, but are not limited thereto. For example, the vertical exposure control signals EXV2 and EXV3 may be generated by delaying the vertical exposure control signal EXV1 by a circuit similar to that of the pixel control unit 42.

### Fourth Embodiment

In the present embodiment, a specific configuration example of a photoelectric conversion device including an avalanche photodiode which can be applied to the ranging device 1 will be described. The configuration example of the present embodiment is an example, and the photoelectric conversion device applicable to the ranging device 1 is not limited thereto.

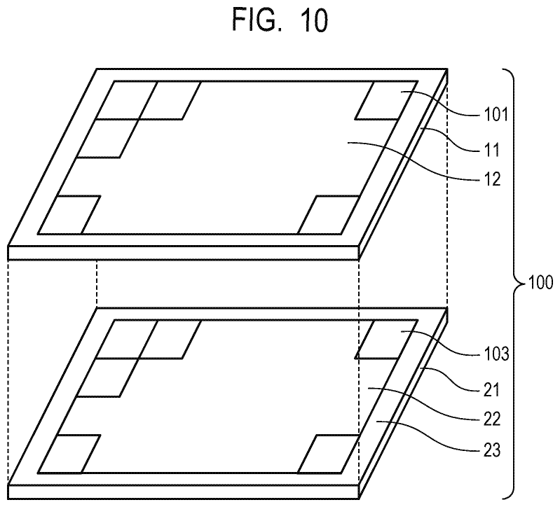

FIG. 10 is a schematic diagram illustrating the overall configuration of the photoelectric conversion device 100 according to the present embodiment. The photoelectric conversion device 100 includes a sensor substrate 11 (first substrate) and a circuit substrate 21 (second substrate) stacked on each other. The sensor substrate 11 and the circuit substrate 21 are electrically connected to each other. The sensor substrate 11 has a pixel region 12 in which a plurality of pixels 101 arranged to form a plurality of rows and a plurality of columns are arranged. The circuit substrate 21 includes a first circuit region 22 in which a plurality of pixel signal processing units 103 are arranged to form a plurality of rows and a plurality of columns, and a second circuit region 23 arranged in the outer periphery of the first circuit region 22. The second circuit region 23 may include a circuit for controlling the plurality of pixel signal processing units 103. The sensor substrate 11 has a light incident surface for receiving incident light and a connection surface opposed to the light incident surface. The sensor substrate 11 is connected to the circuit substrate 21 on the connection surface side. That is, the photoelectric conversion device 100 is a so-called backside illumination type.

In this specification, the term “plan view” refers to a view from a direction perpendicular to a surface opposite to the light incident surface. The cross section indicates a surface in a direction perpendicular to a surface opposite to the light incident surface of the sensor substrate 11. Although the light incident surface may be a rough surface when viewed microscopically, in this case, a plan view is defined with reference to the light incident surface when viewed macroscopically.

In the following description, the sensor substrate 11 and the circuit substrate 21 are diced chips, but the sensor substrate 11 and the circuit substrate 21 are not limited to chips. For example, the sensor substrate 11 and the circuit substrate 21 may be wafers. When the sensor substrate 11 and the circuit substrate 21 are diced chips, the photoelectric conversion device 100 may be manufactured by dicing after being laminated in a wafer state, or may be manufactured by dicing and then stacking them.

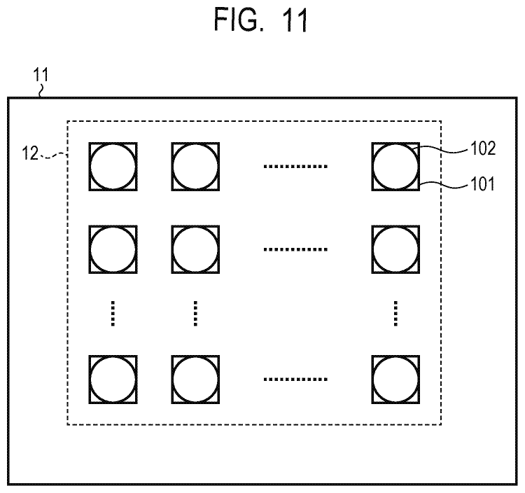

FIG. 11 is a schematic block diagram illustrating an arrangement example of the sensor substrate 11. In the pixel region 12, a plurality of pixels 101 are arranged to form a plurality of rows and a plurality of columns. Each of the plurality of pixels 101 includes a photoelectric conversion unit 102 including an avalanche photodiode (hereinafter referred to as APD) as a photoelectric conversion element in a substrate.

Of the charge pairs generated in the APD, the conductivity type of the charge used as the signal charge is referred to as a first conductivity type. The first conductivity type refers to a conductivity type in which a charge having the same polarity as the signal charge is a majority carrier. Further, a conductivity type opposite to the first conductivity type, i.e., a conductivity type in which majority carriers are charges having a polarity different from that of the signal charge is referred to as a second conductivity type. In the APD described below, the anode of the APD is set to a fixed potential, and a signal is extracted from the cathode of the APD. Accordingly, the semiconductor region of the first conductivity type is an N-type semiconductor region, and the semiconductor region of the second conductivity type is a P-type semiconductor region. Note that the cathode of the APD may have a fixed potential and a signal may be extracted from the anode of the APD. In this case, the semiconductor region of the first conductivity type is a P-type semiconductor region, and the semiconductor region of the second conductivity type is an N-type semiconductor region. Although the case where one node of the APD is set to a fixed potential is described below, potentials of both nodes may be varied.

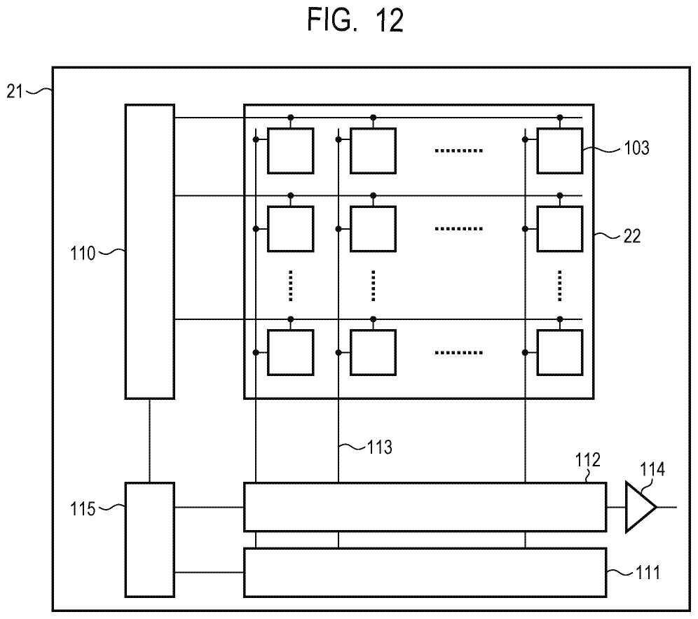

FIG. 12 is a schematic block diagram illustrating a configuration example of the circuit substrate 21. The circuit substrate 21 has a first circuit region 22 in which a plurality of pixel signal processing units 103 are arranged to form a plurality of rows and a plurality of columns.

The circuit substrate 21 includes a vertical scanning circuit 110, a horizontal scanning circuit 111, a reading circuit 112, a pixel output signal line 113, an output circuit 114, and a control signal generation unit 115. The plurality of photoelectric conversion units 102 illustrated in FIG. 11 and the plurality of pixel signal processing units 103 illustrated in FIG. 12 are electrically connected to each other via connection wirings provided for each pixel 101.

The control signal generation unit 115 is a control circuit that generates control signals for driving the vertical scanning circuit 110, the horizontal scanning circuit 111, and the reading circuit 112, and supplies the control signals to these unit. As a result, the control signal generation unit 115 controls the driving timing and the like of each unit.

The vertical scanning circuit 110 supplies a control signal to each of the plurality of pixel signal processing units 103 based on the control signal supplied from the control signal generation unit 115. The vertical scanning circuit 110 supplies a control signal for each row to each pixel signal processing unit 103 via a driving line provided for each row of the first circuit region 22. As will be described later, a plurality of driving lines may be provided for each row. A logic circuit such as a shift register or an address decoder can be used for the vertical scanning circuit 110. Thus, the vertical scanning circuit 110 selects a row to output signals from the pixel signal processing unit 103.

The signal output from the photoelectric conversion unit 102 of the pixel 101 is processed by the pixel signal processing unit 103. The pixel signal processing unit 103 counts pulses output from the APD included in the photoelectric conversion unit 102 to acquire and hold a digital signal.

The pixel signal processing unit 103 need not necessarily be provided for each pixel 101. For example, one pixel signal processing unit 103 may be shared by a plurality of pixels 101. In this case, the pixel signal processing unit 103 sequentially processes the signals output from the photoelectric conversion units 102, thereby providing a function of signal processing to each pixel 101.

The horizontal scanning circuit 111 supplies a control signal to the reading circuit 112 based on the control signal supplied from the control signal generation unit 115. The pixel signal processing unit 103 is connected to the reading circuit 112 via a pixel output signal line 113 provided for each column of the first circuit region 22. The pixel output signal line 113 in one column is shared by a plurality of pixel signal processing unit 103 in the corresponding column. The pixel output signal line 113 includes a plurality of wirings, and has at least a function of outputting a digital signal from the pixel signal processing unit 103 to the reading circuit 112, and a function of supplying a control signal for selecting a column for outputting a signal to the pixel signal processing unit 103. The reading circuit 112 outputs a signal to an external storage unit or signal processing unit of the photoelectric conversion device 100 via the output circuit 114 based on the control signal supplied from the control signal generation unit 115.

The arrangement of the photoelectric conversion units 102 in the pixel region 12 may be one-dimensional. Further, the function of the pixel signal processing unit 103 does not necessarily have to be provided for each of all the pixels 101. For example, one pixel signal processing unit 103 may be shared by a plurality of pixels 101. In this case, the pixel signal processing unit 103 sequentially processes the signals output from the photoelectric conversion units 102, thereby providing a function of signal processing to each pixel 101.

As illustrated in FIGS. 11 and 12, a first circuit region 22 in which a plurality of pixel signal processing unit 103 are arranged is arranged in a region overlapping the pixel region 12 in a plan view. In the plan view, the vertical scanning circuit 110, the horizontal scanning circuit 111, the reading circuit 112, the output circuit 114, and the control signal generation unit 115 are disposed so as to overlap between an edge of the sensor substrate 11 and an edge of the pixel region 12. In other words, the sensor substrate 11 includes the pixel region 12 and the non-pixel region arranged around the pixel region 12. In the circuit substrate 21, the second circuit region 23 (described above in FIG. 10) in which the vertical scanning circuit 110, the horizontal scanning circuit 111, the reading circuit 112, the output circuit 114, and the control signal generation unit 115 are arranged is arranged in an area overlapping with the non-pixel area in the plan view.

Note that the arrangement of the pixel output signal line 113, the arrangement of the reading circuit 112, and the arrangement of the output circuit 114 are not limited to those illustrated in FIG. 12. For example, the pixel output signal lines 113 may extend in the row direction, and may be shared by a plurality of pixel signal processing units 103 in corresponding rows. The reading circuit 112 may be provided so as to be connected to the pixel output signal line 113 of each row.

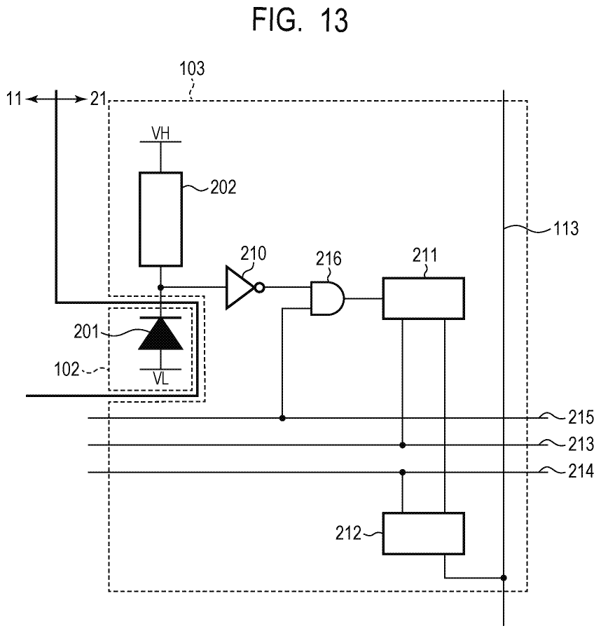

FIG. 13 is a schematic block diagram illustrating a configuration example of one pixel of the photoelectric conversion unit 102 and the pixel signal processing unit 103 according to the present embodiment. FIG. 13 schematically illustrates a more specific configuration example including a connection relationship between the photoelectric conversion unit 102 disposed on the sensor substrate 11 and the pixel signal processing unit 103 disposed on the circuit substrate 21. In FIG. 13, driving lines between the vertical scanning circuit 110 and the pixel signal processing unit 103 in FIG. 12 are illustrated as driving lines 213, 214, and 215.

The photoelectric conversion unit 102 includes an APD 201. The pixel signal processing unit 103 includes a quenching element 202, a waveform shaping unit 210, a counter circuit 211, a selection circuit 212, and a gating circuit 216. The pixel signal processing unit 103 may include at least one of the waveform shaping unit 210, the counter circuit 211, the selection circuit 212, and the gating circuit 216.

The APD 201 generates electric charges corresponding to incident light by photoelectric conversion. A voltage VL (first voltage) is supplied to the anode of the APD 201. The cathode of the APD 201 is connected to the first terminal of the quenching element 202 and the input terminal of the waveform shaping unit 210. A voltage VH (second voltage) higher than the voltage VL supplied to the anode is supplied to the cathode of the APD 201. As a result, a reverse bias voltage that causes the APD 201 to perform the avalanche multiplication operation is supplied to the anode and the cathode of the APD 201. In the APD 201 to which the reverse bias voltage is supplied, when a charge is generated by the incident light, this charge causes avalanche multiplication, and an avalanche current is generated.

The operation modes in the case where a reverse bias voltage is supplied to the APD 201 include a Geiger mode and a linear mode. The Geiger mode is a mode in which a potential difference between the anode and the cathode is higher than a breakdown voltage, and the linear mode is a mode in which a potential difference between the anode and the cathode is near or lower than the breakdown voltage.

An APD operated in the Geiger mode is referred to as SPAD (Single Photon Avalanche Diode). At this time, for example, the voltage VL (first voltage) is-30 V, and the voltage VH (second voltage) is 1 V. The APD 201 may operate in the linear mode or the Geiger mode. In the case of SPAD, a potential difference becomes larger than that of APD of the linear mode, and the effect of avalanche multiplication becomes significant, so that SPAD is preferable.

The quenching element 202 functions as a load circuit (quenching circuit) when a signal is multiplied by avalanche multiplication. The quenching element 202 suppresses the voltage supplied to the APD 201 and suppresses the avalanche multiplication (quenching operation). Further, the quenching element 202 returns the voltage supplied to the APD 201 to the voltage VH by passing a current corresponding to the voltage drop due to the quenching operation (recharge operation). The quenching element 202 may be, for example, a resistive element.

The waveform shaping unit 210 shapes the potential change of the cathode of the APD 201 obtained at the time of photon detection, and outputs a pulse signal. As the waveform shaping unit 210, for example, an inverter circuit is used. Although FIG. 13 illustrates an example in which one inverter is used as the waveform shaping unit 210, the waveform shaping unit 210 may be a circuit in which a plurality of inverters are connected in series, or may be another circuit having a waveform shaping effect.

The gating circuit 216 performs gating such that the pulse signal output from the waveform shaping unit 210 passes through for a predetermined period. During a period in which a pulse signal can pass through the gating circuit 216, photons incident on the APD 201 are counted by the counter circuit 211 in the subsequent stage. Accordingly, the gating circuit 216 controls an exposure period during which a signal based on incident light is generated in the pixel 101. The period during which the pulse signal passes is controlled by a control signal supplied from the vertical scanning circuit 110 through the driving line 215. FIG. 13 illustrates an example in which one AND circuit is used as the gating circuit 216. A pulse signal and a control signal are input to two input terminals of the AND circuit. The AND circuit outputs a logical product of those to the counter circuit 211. The gating circuit 216 may have a circuit configuration other than the AND circuit as long as it realizes gating. The waveform shaping unit 210 and the gating circuit 216 may be integrated by using a logic circuit such as a NAND circuit.

The counter circuit 211 counts the pulse signals output from the waveform shaping unit 210 via the gating circuit 216, and holds a digital signal indicating the count value. When a control signal is supplied from the vertical scanning circuit 110 through the driving line 213, the counter circuit 211 resets the held signal. The counter circuit 211 may be, for example, a 1-bit counter.

The selection circuit 212 is supplied with a control signal from the vertical scanning circuit 110 illustrated in FIG. 12 through the driving line 214 illustrated in FIG. 13. In response to this control signal, the selection circuit 212 switches between the electrical connection and the non-connection of the counter circuit 211 and the pixel output signal line 113. The selection circuit 212 includes, for example, a buffer circuit for outputting a signal corresponding to a value held in the counter circuit 211.

In the example of FIG. 13, the selection circuit 212 switches between the electrical connection and the non-connection of the counter circuit 211 and the pixel output signal line 113; however, the method of controlling the signal output to the pixel output signal line 113 is not limited thereto. For example, a switch such as a transistor may be disposed at a node such as between the quenching element 202 and the APD 201 or between the photoelectric conversion unit 102 and the pixel signal processing unit 103, and the signal output to the pixel output signal line 113 may be controlled by switching the electrical connection and the non-connection. Alternatively, the signal output to the pixel output signal line 113 may be controlled by changing the value of the voltage VH or the voltage VL supplied to the photoelectric conversion unit 102 using a switch such as a transistor.

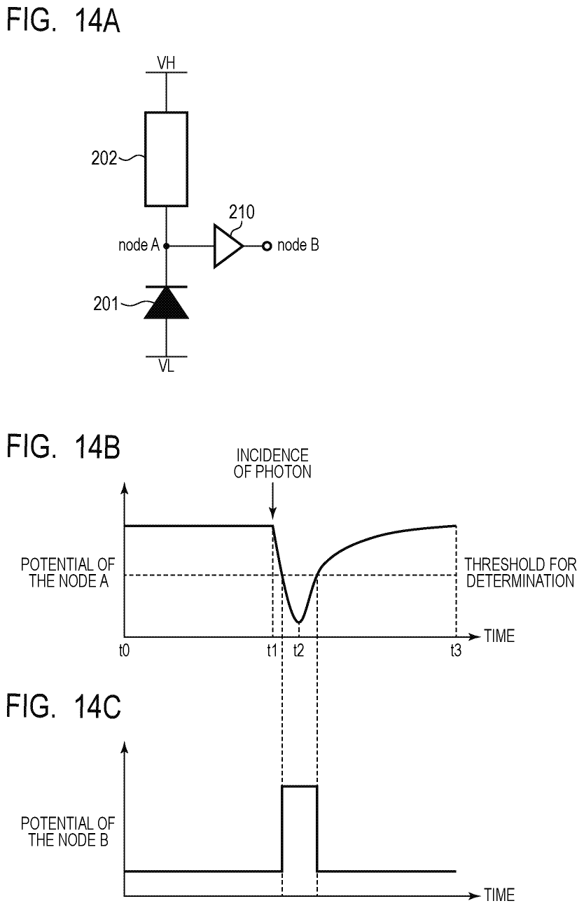

FIGS. 14A, 14B, and 14C are diagrams illustrating the operation of the APD 201 according to the present embodiment. FIG. 14A is a diagram illustrating the APD 201, the quenching element 202, and the waveform shaping unit 210 in FIG. 13. As illustrated in FIG. 14A, the connection node of the APD 201, the quenching element 202, and the input terminal of the waveform shaping unit 210 is referred to as node A. Further, as illustrated in FIG. 14A, the output side of the waveform shaping unit 210 is referred to as node B.

FIG. 14B is a graph illustrating a temporal change in the potential of node A in FIG. 14A. FIG. 14C is a graph illustrating a temporal change in the potential of node B in FIG. 14A. During the period from the time t0 to the time t1, the voltage VH-VL is applied to the APD 201 in FIG. 14A. When a photon enter the APD 201 at time t1, avalanche multiplication occurs in the APD 201. As a result, an avalanche current flows through the quenching element 202, and the potential of the node A drops. Thereafter, the amount of potential drop further increases, and the voltage applied to the APD 201 gradually decreases. Then, at time t2, the avalanche multiplication in the APD 201 stops. Thereby, the voltage level of node A does not drop below a certain constant value. Then, during a period from the time t2 to the time t3, a current that compensates for the voltage drop flows from the node of the voltage VH to the node A, and the node A is settled to the original potential at the time t3.

In the above-described process, the potential of node B becomes the high level in a period in which the potential of node A is lower than a certain threshold value. In this way, the waveform of the drop of the potential of the node A caused by the incidence of the photon is shaped by the waveform shaping unit 210 and output as a pulse to the node B.

According to the present embodiment, a photoelectric conversion device using an avalanche photodiode which can be applied to the ranging device 1 is provided.

### Fifth Embodiment

The method of making exposure periods of a plurality of pixels different by the delay circuit described in the first to third embodiments can be applied to various configurations. In the following embodiments, application examples thereof will be described. In the following embodiments, the method of delaying the gate pulse by the delay circuit of the above-described embodiments can be applied to a method in which the timing of the gate pulse is different between pixels.

Although the pixel array in which three rows and three columns are one unit is described in the first embodiment, an example of the pixel array in which two rows and two columns are one unit is described in the following modified example. The present embodiment is an example of a pixel configuration and a driving method substantially similar to those of the first embodiment except for the unit of a pixel array, and an example of a driving method in the case of a pixel array having two rows and two columns as one unit will be described. In the present embodiment, the description of elements common to those of the above-described embodiments may be omitted or simplified.

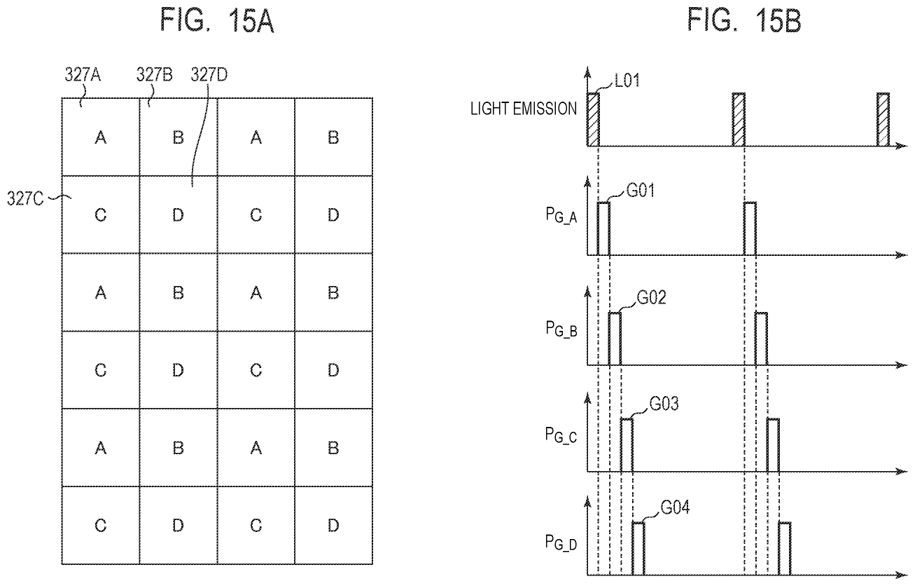

In the present embodiment, a plurality of pixels in the light receiving unit 40 are divided into four types of pixel groups. The exposure periods for reading the micro-frames are different from each other for each pixel group. A specific example will be described with reference to FIGS. 15A and 15B. FIG. 15A is a schematic diagram illustrating an arrangement of pixel groups in the pixel array (pixel array portion of the light receiving unit 40) according to the present embodiment, and FIG. 15B is a driving timing diagram illustrating a timing (exposure period) of gate pulses according to the present embodiment.

The pixel array of the present embodiment includes a first pixel group 327A (“A” in FIG. 15A), a second pixel group 327B (“B” in FIG. 15A), a third pixel group 327C (“C” in FIG. 15A), and a fourth pixel group 327D (“D” in FIG. 15A). As illustrated in FIG. 15A, the first pixel group 327A, the second pixel group 327B, the third pixel group 327C, and the fourth pixel group 327D forms a block including four pixels, and the block forms a two-dimensional repeating array.

In FIG. 15B, “light emission” indicates the light emission timing of the light emitting unit 20. As illustrated in FIG. 15B, the light emitting unit 20 emits light at a constant period. This period corresponds to the length of one micro-frame period during which the acquisition of the micro-frame is performed once. In FIG. 15B, “P_{G_A}” to “P_{G_D}” indicate timings of the exposure control signals. “P_{G_A}”, “P_{G_B}”, “P_{G_C}”, and “P_{G_D}” represent different exposure control signals for controlling the first pixel group 327A, the second pixel group 327B, the third pixel group 327C, and the fourth pixel group 327D, respectively. Hereinafter, a pulse corresponding to a period during which the exposure control signal temporarily becomes the high level is referred to as a gate pulse. Gate pulses synchronized with the light emission timing L01 corresponding to the first pixel group 327A, the second pixel group 327B, the third pixel group 327C, and the fourth pixel group 327D are referred to as gate pulses G01, G02, G03, and G04, respectively. The gate pulses G01, G02, G03, and G04 become the high level after a predetermined time has elapsed from the light emission of the light emitting unit 20, and the periods during which the gate pulses G01, G02, G03, and G04 become the high level in one micro-frame period are different from each other. In other words, the gate pulses G01, G02, G03, and G04 become the high level at the time when the first time, the second time, the third time, and the fourth time which are different from each other have elapsed from the light emission of the light emitting unit 20. The first time to the fourth time are all shorter than the length of the micro-frame period.

By making the timings of the gate pulses G01, G02, G03, and G04 different from each other in this manner, the exposure times of the first pixel group 327A, the second pixel group 327B, the third pixel group 327C, and the fourth pixel group 327D can be different from each other. Therefore, four kinds of ranging points can be measured within one micro-frame period.

As described above, by adding a plurality of micro-frames, one sub-frame is generated. That is, the first pixel group 327A, the second pixel group 327B, the third pixel group 327C, and the fourth pixel group 327D output signals for generating sub-frames at different ranging points. When one sub-frame is generated, the timing of the gate pulses in the first pixel group 327A is shifted by a predetermined time interval from the timing of the gate pulses in the current sub-frame period at the start of the next sub-frame period. Similarly, gate shifting is performed for the second pixel group 327B, the third pixel group 327C, and the fourth pixel group 327D. By such gate shifting, a predetermined period corresponding to each sub-frame period can be set as the exposure period.

In this way, by making the exposure times of the plurality of pixel groups different from each other and performing gate shifting for each sub-frame period for each of the plurality of pixel groups, the number of gate shifts necessary for measuring the necessary number of ranging points is reduced. This shortens the total period of a plurality of sub-frames, i.e., the length of the frame period. Therefore, the frame rate can be improved without reducing the number of ranging points (distance resolution). As described above, according to the present embodiment, a photoelectric conversion device with an improved frame rate is provided.

Although the number of types of pixel groups is set to four in the present embodiment, the number of types of pixel groups may be at least two, and even if the number of types of pixel groups is other than four, the frame rate can be improved. The number of photoelectric conversion elements included in one pixel group may be at least one. That is, for two photoelectric conversion elements (the first photoelectric conversion element and the second photoelectric conversion element), if the first exposure period of the first photoelectric conversion element and the second exposure period of the second photoelectric conversion element are different from each other in one micro-frame period, the above-described effect can be obtained. The arrangement of the pixel groups is not limited to that illustrated in FIG. 15A, and can be appropriately changed.

In the present embodiment, by disposing a plurality of pixel groups, although an effect of improving the frame rate can be obtained, the resolution in the plane of the ranging image may be reduced. Therefore, such a method of reducing the influence on the resolution in a plane may be further applied by complementing pixels lacking information in a ranging image with peripheral pixels.

### Sixth Embodiment

In the present embodiment, another example of the arrangement of the pixel groups and the timing of the gate pulses described in the fifth embodiment will be described. Elements common to the above-described embodiments may be appropriately omitted or simplified.

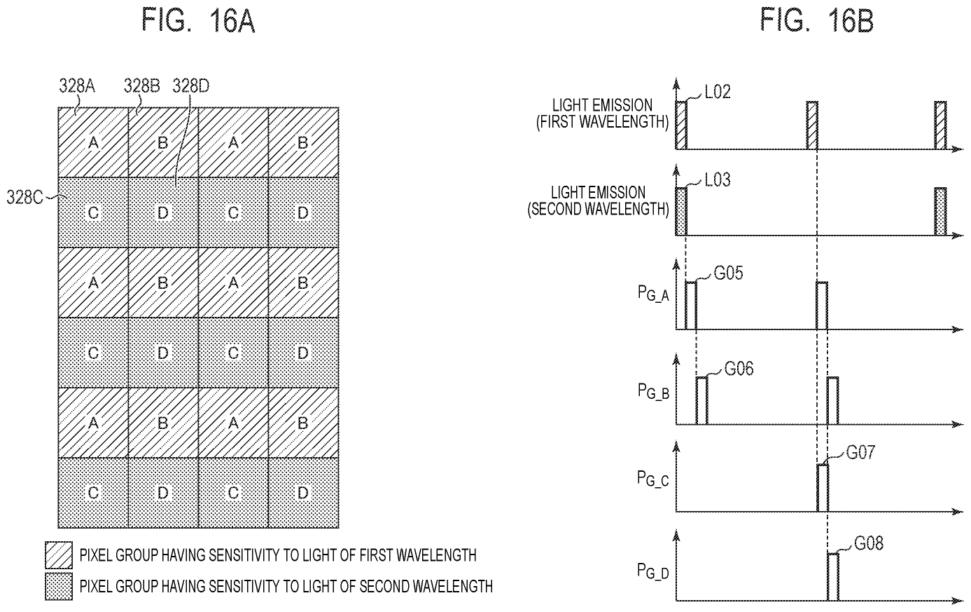

FIG. 16A is a schematic diagram illustrating the arrangement of pixel groups in the pixel array according to the present embodiment, and FIG. 16B is a driving timing diagram illustrating the timing of gate pulses according to the present embodiment.

The pixel array of the present embodiment includes a first pixel group 328A (“A” in FIG. 16A), a second pixel group 328B (“B” in FIG. 16A), a third pixel group 328C (“C” in FIG. 16A), and a fourth pixel group 328D (“D” in FIG. 16A). The first pixel group 328A and the second pixel group 328B are configured to have sensitivity to light of a first wavelength. The third pixel group 328C and the fourth pixel group 328D are configured to have sensitivity to light of a second wavelength different from the first wavelength. More specifically, the first pixel group 328A and the second pixel group 328B are provided with a first color filter that transmits light of the first wavelength, and the third pixel group 328C and the fourth pixel group 328D are provided with a second color filter that transmits light of the second wavelength. Each of the ranges of the first wavelength and the second wavelength in the present embodiment may be, for example, an infrared region.

The light emitting unit 20 of the present embodiment is configured to emit light of a first wavelength and light of a second wavelength individually at different cycles. In FIG. 16B, “light emission (first wavelength)” indicates the emission timing of light of the first wavelength by the light emitting unit 20. In FIG. 16B, “light emission (second wavelength)” indicates the emission timing of light of the second wavelength by the light emitting unit 20. As illustrated in FIG. 16B, the lengths of the emission cycles of the light of the first wavelength and the light of the second wavelength are different from each other. In the example of FIG. 16B, the length of the light emission cycle of the light of the second wavelength is twice the length of the light emission cycle of the light of the first wavelength.

Gate pulses G05 and G06 are input to the first pixel group 328A and the second pixel group 328B at timings synchronized with the light emission timing L02 of the light of the first wavelength. Gate pulses G07 and G08 are input to the third pixel group 328C and the fourth pixel group 328D at timings delayed by one cycle of light emission of the first wavelength from light emission timing L03 of light of the second wavelength. Therefore, the acquisition cycle of the micro-frame for the first pixel group 328A and the second pixel group 328B and the acquisition cycle of the micro-frame for the third pixel group 328C and the fourth pixel group 328D are different from each other. With this setting, the first pixel group 328A and the second pixel group 328B are used as a pixel group for ranging of a short distance (first distance range), and the third pixel group 328C and the fourth pixel group 328D are used as a pixel group for ranging of a long distance (second distance range). Thus, a plurality of different ranging areas can be measured within the same sub-frame period. In general, in the method of repeatedly acquiring and adding the micro-frames of the 1-bit signal, the ranging area is limited by the repetition cycle of the light emission pulse, but in the method of the present embodiment, since both the short-distance and long-distance signals can be acquired, a wide range of ranging is possible.

As described above, according to the present embodiment, in addition to the effects similar to those of the fifth embodiment, the photoelectric conversion device capable of collectively acquiring a plurality of different ranging areas without lowering the frame rate is provided.

In the present embodiment, the bit depth of the signal of the sub-frame obtained from the pixel group for short-distance ranging and the bit depth of the signal of the sub-frame obtained from the pixel group for long-distance ranging may be different from each other. When the number of additions of the signal for short-distance ranging is 64, a sub-frame for short-distance ranging of 6-bit depth is obtained. In this case, since the number of times of emission of light of the second wavelength is half the number of times of emission of light of the first wavelength, the number of times of addition of the signal for long-distance ranging is 32 at the maximum. Thus, the sub-frame for long-distance ranging is 5-bit depth. When the bit depths of the two signals are different from each other, the bit depth may be adjusted.

In the present embodiment, the number of wavelengths of light emitted from the light emitting unit 20 is two, but may be three or more. Further, the ratio of the cycles of light having different wavelengths is not limited to twice, and can be appropriately set. Further, the cycle between the emission timings of the light of the first wavelength is shorter than the cycle between the emission timings of the light of the second wavelength. Therefore, for example, in the case where the object is approaching, the reflected light based on the n-th emission and the reflected light based on the (n+1)-th emission may not be distinguished. Therefore, it is also possible to control such that the light intensity of the n-th light emission differs from the light intensity of the (n+1)-th light emission. Thus, it is possible to determine which timing of the light emission the reflected light is based on.

### Seventh Embodiment

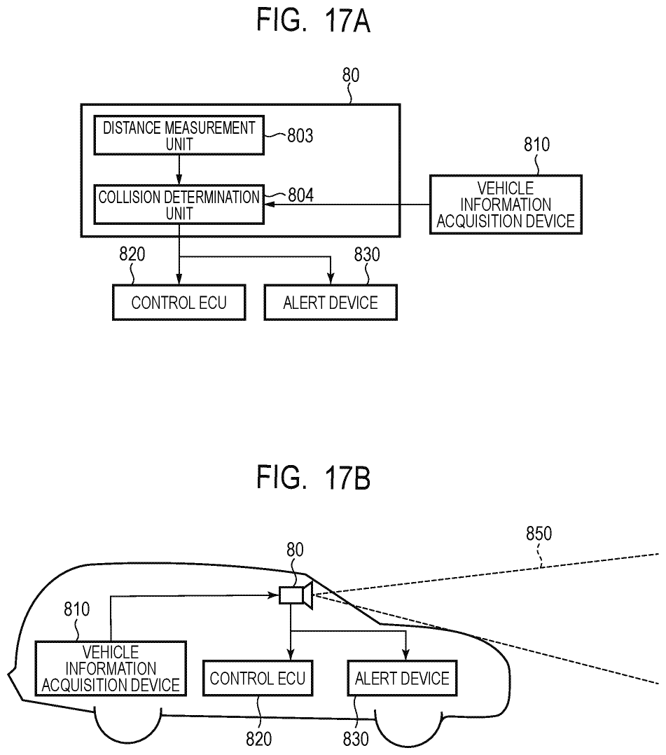

FIGS. 17A and 17B are block diagrams of equipment relating to an in-vehicle ranging device according to the present embodiment. Equipment 80 includes a distance measurement unit 803, which is an example of the ranging device 1 of the above-described embodiments, and a signal processing device (processing device) that processes a signal from the distance measurement unit 803. The equipment 80 includes the distance measurement unit 803 that measures a distance to an object, and a collision determination unit 804 that determines whether or not there is a possibility of collision based on the measured distance. The distance measurement unit 803 is an example of a distance information acquisition unit that obtains distance information to the object. That is, the distance information is information on a distance to the object or the like. The collision determination unit 804 may determine the collision possibility using the distance information.

The equipment 80 is connected to a vehicle information acquisition device 810, and can obtain vehicle information such as a vehicle speed, a yaw rate, and a steering angle. Further, the equipment 80 is connected to a control ECU 820 which is a control device that outputs a control signal for generating a braking force to the vehicle based on the determination result of the collision determination unit 804. The equipment 80 is also connected to an alert device 830 that issues an alert to the driver based on the determination result of the collision determination unit 804. For example, when the collision possibility is high as the determination result of the collision determination unit 804, the control ECU 820 performs vehicle control to avoid collision or reduce damage by braking, returning an accelerator, suppressing engine output, or the like. The alert device 830 alerts the user by sounding an alarm, displaying alert information on a screen of a car navigation system or the like, or giving vibration to a seat belt or a steering wheel. These devices of the equipment 80 function as a movable body control unit that controls the operation of controlling the vehicle as described above.

In the present embodiment, ranging is performed in an area around the vehicle, for example, a front area or a rear area by the equipment 80. FIG. 17B illustrates equipment when ranging is performed in the front area of the vehicle (ranging area 850). The vehicle information acquisition device 810 as a ranging control unit sends an instruction to the equipment 80 or the distance measurement unit 803 to perform the ranging operation. With such a configuration, the accuracy of ranging can be further improved.

Although the example of control for avoiding a collision to another vehicle has been described above, the embodiment is applicable to automatic driving control for following another vehicle, automatic driving control for not going out of a traffic lane, or the like. Furthermore, the equipment is not limited to a vehicle such as an automobile and can be applied to a movable body (movable apparatus) such as a ship, an airplane, a satellite, an industrial robot and a consumer use robot, or the like, for example. In addition, the equipment can be widely applied to equipment which utilizes object recognition or biometric authentication, such as an intelligent transportation system (ITS), a surveillance system, or the like without being limited to movable bodies.

### Modified Embodiments

The present disclosure is not limited to the above-described embodiments, and various modifications are possible. For example, an example in which some of the configurations of any one of the embodiments are added to other embodiments and an example in which some of the configurations of any one of the embodiments are replaced with some of the configurations of other embodiments are also embodiments of the present disclosure.

The disclosure of this specification includes a complementary set of the concepts described in this specification. In other words, in this specification, for example, if there is a description of “A is B” (A=B), this specification is intended to disclose or suggest that “A is not B” even if a description of “A is not B” (A≠B) is omitted. This is because when “A is B” is described, it is assumed that the case of “A is not B” is considered.

According to the present disclosure, a photoelectric conversion device capable of improving a frame rate is provided.

Embodiment(s) of the disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-040928, filed Mar. 15, 2023, which is hereby incorporated by reference herein in its entirety.

What is claimed is:

1. A photoelectric conversion device comprising:
a light receiving unit including a plurality of pixels each configured to detect incident light and generate a signal based on the incident light; and
a plurality of pixel control units each configured to control an exposure period during which a signal based on the incident light is generated in a corresponding pixel among the plurality of pixels,
wherein the plurality of pixel control units includes a first pixel control unit and a second pixel control unit,
wherein the first pixel control unit controls a first exposure period in a first pixel among the plurality of pixels based on a first exposure control signal, generates a second exposure control signal by delaying the first exposure control signal, and outputs the second exposure control signal to the second pixel control unit,
wherein the second pixel control unit controls a second exposure period in a second pixel among the plurality of pixels based on the second exposure control signal,
wherein the second pixel control unit includes a selection circuit configured to enable either the first exposure control signal or the second exposure control signal based on a selection signal,
wherein in a case where the first exposure control signal is enabled, the second pixel control unit controls the second exposure period based on the first exposure control signal such that a start time of the second exposure period coincides with a start time of the first exposure period, and
wherein in a case where the second exposure control signal is enabled, the second pixel control unit controls the second exposure period based on the second exposure control signal such that the start time of the second exposure period is later than the start time of the first exposure period.

2. The photoelectric conversion device according to claim 1,
wherein each of the plurality of pixel control units includes the selection circuit, and
wherein the selection signal of a common level is input to the selection circuit of each of the plurality of pixel control units.

3. The photoelectric conversion device according to claim 1 further comprising:
a light emitting unit; and
a control unit configured to control timing of light emission in the light emitting unit and the first pixel control unit.

4. The photoelectric conversion device according to claim 3, wherein the control unit outputs the first exposure control signal to the first pixel control unit so that the first exposure period starts at the same time as the timing of light emission in the light emitting unit or after a predetermined time has elapsed from the timing of light emission in the light emitting unit.

5. The photoelectric conversion device according to claim 1 further comprising a frequency distribution holding unit configured to hold a frequency distribution based on a frequency of a signal based on the incident light in the first exposure period and a frequency of a signal based on the incident light in the second exposure period.

6. The photoelectric conversion device according to claim 5,
wherein one of the plurality of pixel control units controls exposure periods of two or more pixels to be the same, and
wherein the frequency distribution holding unit sets frequencies of signals output from the two or more pixels as a common class in the frequency distribution.

7. The photoelectric conversion device according to claim 1,
wherein the plurality of pixels are arranged to form a plurality of rows and a plurality of columns, and
wherein the first pixel and the second pixel are arranged in different columns of the same row.

8. The photoelectric conversion device according to claim 7,
wherein the first pixel control unit is arranged to supply the first exposure control signal to two or more pixels in a first column including the first pixel, and
wherein the second pixel control unit is arranged to supply the second exposure control signal to two or more pixels in a second column including the second pixel.

9. The photoelectric conversion device according to claim 8 further comprising an AND circuit arranged corresponding to each of the plurality of pixels,
wherein a third exposure control signal and the first exposure control signal are input to the AND circuit of the first column, and
wherein the third exposure control signal and the second exposure control signal are input to the AND circuit of the second column.

10. The photoelectric conversion device according to claim 9, wherein the third exposure control signal is input to a plurality of AND circuits of one row in common.

11. The photoelectric conversion device according to claim 10,
wherein the third exposure control signal is input to the AND circuits of the first row among the plurality of rows in common, and
wherein the third exposure control signal that is delayed is input to the AND circuits of the second row among the plurality of rows.

12. The photoelectric conversion device according to claim 1, wherein an interval between the start time of the first exposure period and the start time of the second exposure period is equal to a length of the first exposure period.

13. The photoelectric conversion device according to claim 1, wherein a length of the first exposure period and a length of the second exposure period are equal to each other.

14. The photoelectric conversion device according to claim 1, wherein the plurality of pixels include a pixel sensitive to light of a first wavelength and a pixel sensitive to light of a second wavelength different from the first wavelength.

15. The photoelectric conversion device according to claim 14, wherein the plurality of pixels generate a signal for ranging in a first distance range based on light of the first wavelength, and generate a signal for ranging in a second distance range different from the first distance range based on light of the second wavelength.

16. The photoelectric conversion device according to claim 15, wherein a cycle in which the signal for ranging in the first distance range is generated and a cycle in which the signal for ranging in the second distance range is generated are different from each other.

17. The photoelectric conversion device according to claim 14, wherein the first wavelength and the second wavelength are both in an infrared region.

18. A movable body comprising:
the photoelectric conversion device according to claim 1; and
a movable body control unit configured to control the movable body based on distance information acquired by the photoelectric conversion device.
